(19) United States
(12) Patent Application Publication
(10) Pub. No.: US 2004/0108800 A1
(43) Pub. Date: Jun. 10, 2004

(54) Electrodeless fluorescent lamp

(76) Inventors: Kazuaki Ohkubo, Osaka (JP); Mitsuharu Kawasaki, Osaka (JP); Shingo Matsuda, Shiga (JP); Akira Hochi, Nara (JP); Kiyoshi Hashimotodani, Osaka (JP); Yuuji Omata, Osaka (JP); Yoshihisa Hagiwara, Hyogo (JP)

Correspondence Address: HARNESS, DICKEY & PIERCE, P.L.C., P.O. BOX 828, BLOOMFIELD HILLS, MI, 48303, US

(21) Appl. No.: 10/621,798

(22) Filed: Jul. 17, 2003

(30) Foreign Application Priority Data
Jul. 19, 2002 (JP) 2002-210730

(51) Int. Cl. H01J 65/00; H01J 63/04

(52) U.S. Cl. 313/155; 313/485

(57) ABSTRACT

An electrodeless fluorescent lamp according to the present invention includes: a luminous bulb in which mercury in a liquid state is enclosed as a light emitting substance and which includes a cavity portion; an induction coil which is inserted into the cavity portion and generates an electromagnetic field for generating electric discharge in the luminous bulb; a ballast circuit electrically connected to the induction coil; and a luminophor layer which is provided on the inner surface of the luminous bulb and converts light radiated from the mercury to visible light. In the electrodeless fluorescent lamp, a manganese-activated deep red luminescent substance (3.5MgO·0.5 MgF₂.GeO₂:Mn4⁺) is contained only in part of the luminophor layer provided on a surface of the cavity portion facing the inner surface of the luminous bulb.

### BACKGROUND OF THE INVENTION

The present invention relates to electrodeless fluorescent lamps, and more particularly relates to an electrodeless fluorescent lamp in which mercury in a liquid state exits within a luminous bulb.

In recent years, to cope with the problem of global warming and promote effective use of energy resources, efforts to reduce energy consumption have been made in various fields. In the filed of illumination, known incandescent lamps are being shifted to fluorescent lamps with higher energy efficiency, and recently the latter has become widely used.

However, there has been a problem in replacing an incandescent lamp with a fluorescent lamp. That is, an economical incandescent lamp lighting fixture also has to be changed to an expensive lighting fixture with a built-in ballast for operating a fluorescent lamp.

To solve this problem, an incandescent-lamp-substituting fluorescent lamp which can be directly connected to an incandescent lamp socket in an incandescent lamp lighting fixture and includes a base and a ballast was developed. The incandescent-lamp-substituting fluorescent lamp can be used with an incandescent lamp lighting fixture in place of an incandescent lamp and also has high efficiency. The lifetime of the incandescent-lamp-substituting fluorescent lamp is generally over three times as long as that of an incandescent lamp. Therefore, the incandescent-lamp-substituting fluorescent lamp has now been widely used.

On the other hand, for the purpose of further increasing the lifetime of fluorescent lamps, there has been developed an electrodeless fluorescent lamp in which no electrode, causing loss of the lifetime of a fluorescent lamp, is provided. In the electrodeless fluorescent lamp, a noble gas and mercury are enclosed, a high-frequency alternating electromagnetic filed is applied from the outside to a closed glass discharge vessel with a luminophor applied to the inside wall so that mercury vapor discharge is generated within the discharge vessel. Ultraviolet radiation resulting from the mercury vapor discharge excites the luminophor to make it emit light. The electrodeless fluorescent lamp includes no electrode, and thus it is possible to achieve lifetime over twice as long as that of a known electrode-included fluorescent lamp.

As an electrodeless fluorescent lamp, an electrodeless fluorescent lamp including a base and a ballast has been developed for the purpose of providing substitutes for incandescent lamps. Such an electrodeless fluorescent lamp will be hereinafter referred to as an “electrodeless compact self-ballasted fluorescent lamp”.

Being inserted to an incandescent lamp lighting fixture, the electrodeless compact self-ballasted fluorescent lamp is required to emit not only daylight used for known fluorescent lamps but also light almost equivalent to that of an incandescent lamp (warm white: JIS Z 9112-1990 Classification of Fluorescent Lamps by Chromaticity and Colour Rendering). In recent years, there have been demands for development of an electrodeless compact self-ballasted fluorescent lamp whose correlated color temperature is about 2800 K, i.e., which can emit light similar to that of an incandescent lamp.

The light color of a fluorescent lamp is obtained when emission line radiation with a wavelength of 405 nm, 435 nm or 546 nm in the visible wavelength range due to a low-pressure mercury discharge and light emitted from a luminophor are synthesized. The luminophor is excited by ultraviolet radiation with a wavelength of 254 nm or the like generated due to low-pressure mercury discharge, emiting light in the visible wavelength range. The light color of such a fluorescent lamp is adjusted by changing the mixture ratio of several rare earth luminophors emitting blue, green, and red lights.

In an electrodeless compact self-ballasted fluorescent lamp, when it is intended to obtain a high output, a luminous bulb receives an increased load. Accordingly, the temperature of the coldest point in the luminous bulb becomes higher than that in a regular straight-tube fluorescent lamp. When the coldest point temperature is increased in this manner, mercury vapor pressure is increased. Accordingly, the radiation energy of ultraviolet light with a wavelength of 254 nm which is an excitation source for the luminophor is reduced and the energy of emission line radiation in the visible wavelength range is increased. That is to say, blue elements in the light color are increased.

Assume that the coldest point temperature of the luminous bulb is increased in the above-described manner. When a luminophor which emits blue light is removed and then color adjustment is performed with only luminophors which emit green and red lights, respectively, it is difficult to obtain a light color similar to that of an incandescent lamp, i.e., a light color with a correlated color temperature of 2800 K and Duv=0. Note that Duv is a distance of a chromaticity point from a black body locus on a CIE 1960 USC chromaticity diagram (deviation amount from a black body locus: JIS Z8725 Methods for Determining Distribution Temperature and Color Temperature or Correlated Color Temperature of Light Sources).

To solve the above-described problems, a technique in which amalgam is used to suppress an increase in mercury vapor pressure with a valve having an increased temperature is applied to an incandescent-lamp-substituting fluorescent lamp with an electrode, in many cases.

However, when the incandescent-lamp-substituting fluorescent lamp which includes an electrode and in which amalgam is used has been left without being operated for a long time, a problem arises in which the luminous flux of the lamp shows a low rise in an early operation stage. In order to improve a luminous flux rise, an electrodeless fluorescent lamp in which amalgam is not used, i.e., an electrodeless fluorescent lamp in which liquid mercury is enclosed in an electrodeless fluorescent lamp, is used. In this case, as has been described, change in color temperature due to an increase in the coldest point temperature of a luminous bulb becomes a problem.

### SUMMARY OF THE INVENTION

It is therefore an object of the present invention to provide an electrodeless fluorescent lamp in which amalgam for suppressing mercury vapor pressure is not used but only liquid mercury is used and which has a simple structure to generate light having similar light color to that of an incandescent lamp.

An electrodeless fluorescent lamp according to the present invention includes: a luminous bulb in which mercury in a liquid state is enclosed as a light emitting substance and which includes a cavity portion; an induction coil which is inserted into the cavity portion and generates an electromagnetic field for generating electric discharge in the luminous bulb; a ballast circuit electrically connected to the induction coil; and a luminophor layer which is provided on the inner surface of the luminous bulb and converts light radiated from the mercury to visible light, wherein a manganese-activated deep red luminescent substance (3.5MgO·0.5 MgF₂.GeO₂:Mn4⁺) is contained only in part of the luminophor layer provided on a surface of the cavity portion facing the inner surface of the luminous bulb.

Furthermore, it is preferable that the electrodeless fluorescent lamp includes a base electrically connected to the ballast circuit and the luminous bulb, the ballast circuit and the base are formed as a unit.

Moreover, it is preferable that the induction coil includes a core and a winding provided around the core.

### BRIEF DESCRIPTION OF THE DRAWINGS

FIG. 1 is a perspective view of an electrodeless fluorescent lamp according to the present invention.

FIG. 2 is a graph showing chromaticity for an electrodeless fluorescent lamp using LAP and YOX.

FIG. 3 is a graph showing differences in luminous intensity according to coldest point temperature.

FIG. 4 is a graph showing excitation spectrum and emission spectrum for MFG.

### DESCRIPTION OF THE PREFERRED EMBODIMENTS

Before describing embodiments of the present invention, light color of an electrodeless fluorescent lamp as a comparative example in which mercury in a liquid form is enclosed and which includes only green and red light emitting luminophors in a luminophor layer will be described.

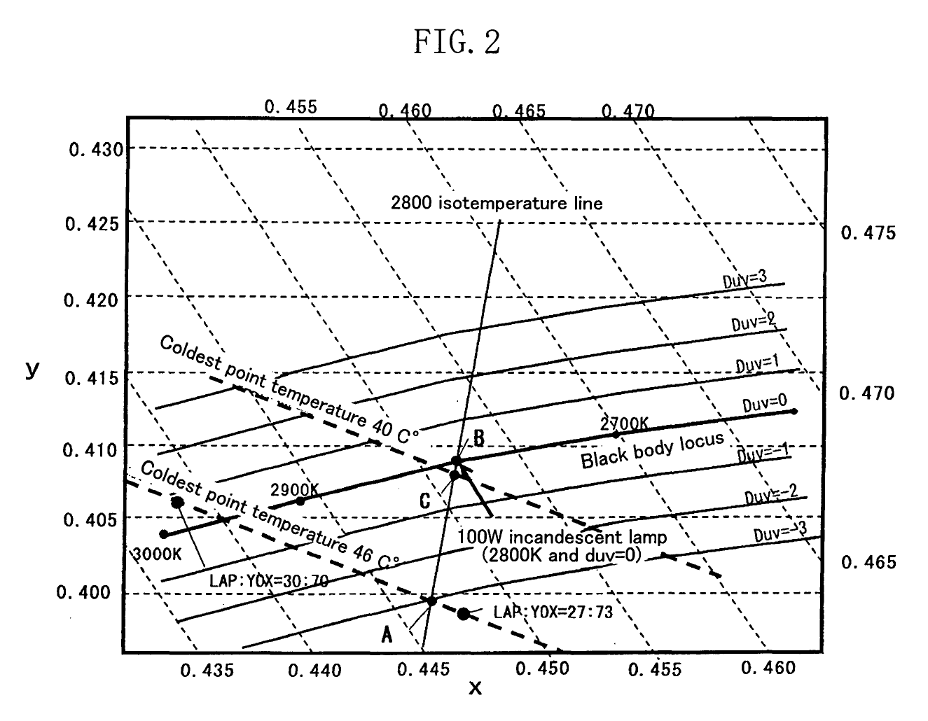

First, FIG. 2 shows xy oblique coordinates for the electrodeless fluorescent lamp of the comparative example. In this case, (x, y) indicates chromaticity coordinates for the electrodeless fluorescent lamp. The 2800 K isotemperature line is formed a set of points representing an isotemperature of 2800 K on the xy oblique coordinates. Each of curves parallel to the black body locus within a Duv range from −3 to 3 is formed of a set of points representing the same shift amount from the black body locus. Normally, in the (x, y) orthogonal coordinate diagram (CIE chromaticity diagram), the isochromaticity area (usually called MacAdam ellipse), which was defined by MacAdam, is indicated by an oval expressed by Equation 1.

g11(x−x0)²+g12(x−x0)(y−y0)+g22(y−y0)²≦a² [Equation 1]

where with a color temperature of 2800 K and Duv=0, g11=40×10⁻⁴, g12=−19×10⁻⁴, g22=28×10⁻⁴, x0=0.4517, y0=0.4086, and a is color difference. The xy oblique coordinates are ordinates obtained by performing coordinate transformation to express the oval by a circle, where the angle ω between the x axis and the y axis is expressed by the following equation.

cos ω=g12/(g11·g22)^{1/2} [Equation 2]

where the ratio of the respective scale lengths of the x axis and the y axis are expressed by:

x:y=(g11)/2: (g22)/2 [Equation 3]

(see The color science association of Japan, Color Science Handbook 2^{nd} edition, p. 273).

A luminophor layer in the electrodeless fluorescent lamp of the comparative example includes two luminophors, i.e., a green light emitting luminophor (e.g., LAP: LaPO₄: Ce³⁺, Tb³⁺) and a red light emitting luminophor (e.g., YOX: Y₂O₃: Eu³⁺). LAP and YOX are luminophors which absorb ultraviolet light and emit visible light. No excitation and emission due to absorption of visible light occurs. A chromaticity locus (LAP-YOX mixture locus) obtained when the ratio of LAP and YOX is changed is plotted on the graph shown in FIG. 2 and indicated by two thick broken lines. The upper thick broken line indicates a chromaticity locus obtained when the temperature of the coldest point in a luminous bulb is 40 C° and the lower thick broken line indicates a chromaticity locus obtained when the coldest point temperature of the luminous bulb is 46 C°. When the LAP ratio is increased, chromaticity is shifted toward upper left on each of the thick broken line. On the other hand, when the YOX ratio is increased, chromaticity is shifted toward lower right on each of the thick broken line. Note that the coldest point temperature when the electrodeless fluorescent lamp of the comparative example is operated at an ambient temperature of 25 C° was 46 C°.

As shown in FIG. 2, with the coldest point temperature of 46 C°, when the electrodeless fluorescent lamp in which only LAP and YOX are used generates light with a color temperature of 2800 K, Duv is about −3 as indicated by the point A. That is to say, the electrodeless fluorescent lamp is largely different from a target 100 W incandescent lamp which generates light with a color temperature of 2800 K and Duv=0 (the point B shown in FIG. 2), and which the electrodeless fluorescent lamp as a substitute for an incandescent lamp aims to achieve.

Note that as the coldest point temperature of the luminous bulb is reduced from 46 C° to 40 C°, a chromaticity locus obtained when the LAP and YOX ratio is changed is shifted toward upper right with being in parallel to the chromaticity locus obtained when the coldest point temperature is 46 C°. When the coldest point temperature is 40 C°, the intersection C of the chromaticity locus obtained when the LAP and YOX ratio is changed and the isotemperature line of 2800 K is located close to the target point B (2800 K and Duv=0). Therefore, with the coldest point temperature of 40 C°, the electrodeless fluorescent lamp of the comparative example can generate a target light color which is the same as that of an incandescent lamp. However, when a high output is intended to obtain, it is very difficult to reduce the coldest point temperature to 40 C°.

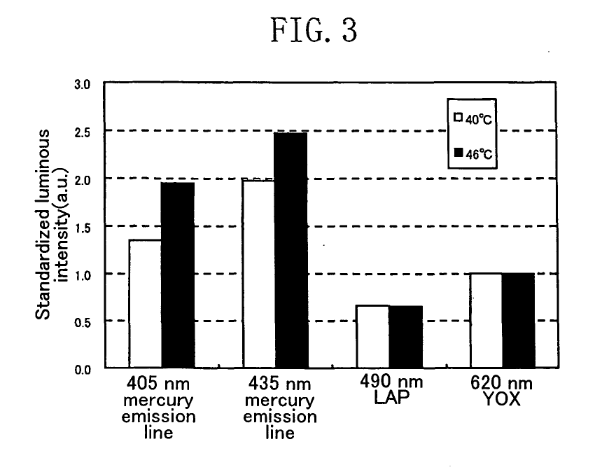

Next, FIG. 3 shows luminous intensity for blue light radiated from the electrodeless discharge lamp of the comparative example, i.e., mercury emission lines (at 405 nm and 435 nm), light with a wavelength of 490 nm (490 nm is the wavelength of one of lights emitted from LAP), and light with a wavelength of 620 nm (620 nm is the wavelength of one of lights emitted from YOX). The intensities shown in FIG. 3 are obtained in two cases where the coldest point temperature is 46 C° and 40 C°. Note that in FIG. 3, it is assumed that each of the respective luminous intensities of the light with a wavelength of 620 nm (which is the wavelength of one of lights emitted from YOX) in the two cases is 1 to standardize the respective luminous intensities of the lights. In FIG. 3, the luminous intensities of the light with a wavelength of 490 nm (which is the wavelength of one of lights emitted from LAP) and the light with a wavelength of 620 nm (which is the wavelength of one of lights emitted from YOX) hardly vary even when the coldest point temperature is changed. Meanwhile, as for blue mercury emission lines at 405 nm and 435 nm, the luminous intensity is larger when the coldest point temperature is 46 C° than when it is 40 C°. This shows that differences in the luminous intensities in the case of the blue mercury emission lines at 405 nm and 435 nm are relatively large, compared to the case of the lights with a wavelength of 490 nm and with a wavelength of 620 nm. More specifically, when the coldest point temperature is 46 C°, the luminous intensities of the mercury emission lines at 405 nm and at 435 nm are increased, compared to the luminous intensities of the respective lights originated from YOX and LAP. Thus, the chromaticity of the electrodeless fluorescent lamp is shifted towards the blue range. Accordingly, the lamp can not generate light with a color temperature of 2800 K and Duv=0.

The above-described fact implies that in order to achieve a target electrodeless fluorescent lamp which generates light with a color temperature of 2800 K and Duv=0, it is important to reduce the luminous intensity of the blue light having the mercury emission lines at 405 nm and at 435 nm when the coldest point temperature is high (e.g., 46 C°). To achieve this target, it is assumed that a luminophor which is excited by the blue mercury emission lines at 405 nm and 435 nm and radiates visible light with a relatively long wavelength may be used. Then, we examined the assumption for many times in order to apply it to an electrodeless fluorescent lamp, and consequently have reached the present invention. Note that a value for Duv can be adjusted by changing other conditions. Therefore, the examinations were conducted with focusing on making the correlated color temperature closer to 2800 K.

Hereinafter, an embodiment according to the present invention will be described with reference to the accompanying drawings. Note that the following embodiment is an example of the present invention, and therefore the present invention is not limited to the embodiment.

(Embodiment)

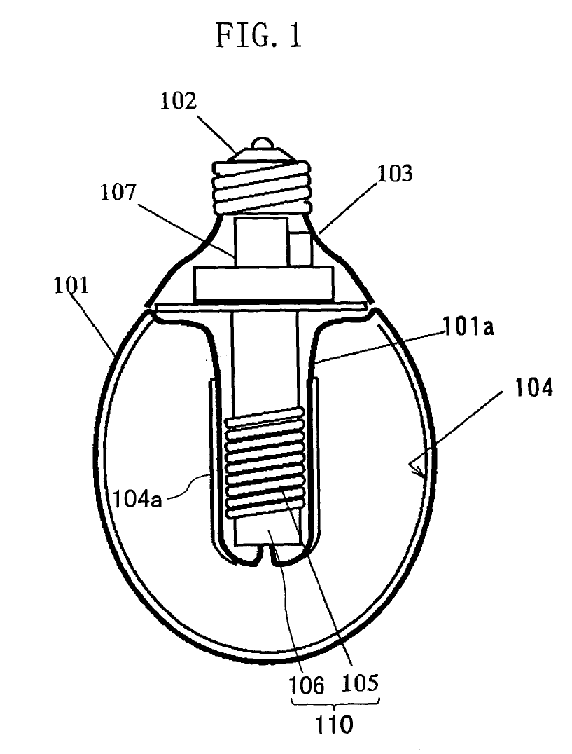

FIG. 1 is a perspective view of an electrodeless fluorescent lamp according to this embodiment.

The electrodeless fluorescent lamp of FIG. 1 includes a luminous bulb 101, a base 102 through which electric power is supplied from a commercial power line, a case 103 for connecting the luminous bulb 101 and the base 102. In the luminous bulb 101, mercury and noble gas (e.g., argon) which are light emitting substances are enclosed (not shown). Mercury enclosed is not in an amalgam form but in a liquid form. However, if temperature properties of an amalgam are almost equivalent to those of liquid mercury at a mercury vapor pressure, the amalgam may be used. More specifically, according to the present invention, the electrodeless fluorescent lamp does not have the structure in which mercury is enclosed in an amalgam form such as Bi-In amalgam which controls the mercury vapor pressure so that the mercury vapor pressure is not increased too much even at an increased temperature in operating the lamp but has the structure in which mercury is enclosed in a liquid form in operating the lamp. Assume that mercury is enclosed as an amalgam containing Zn or Cu in the luminous bulb 101. In this case, mercury becomes a liquid form once the lamp is operated and liquid mercury does not become an amalgam again. Thus, even though an amalgam containing Zn or Cu is enclosed in the luminous bulb 101, it is considered that mercury liquid is enclosed therein.

Moreover, a luminophor is applied to the inner surface of the luminous bulb 101 to form luminophor layers 104, 104a. The luminophor layers 104, 104a convert light radiated from mercury to visible light. Note that radiant light is mostly ultraviolet light but may be visible light. An alumina protective film for reflecting ultraviolet light (not shown) is provided between the luminous bulb 101 and the luminophor layer 104 or 104a. Furthermore, in the luminous bulb 101, a cavity portion 101a having an approximately cylindrical shape is formed so as to extend from the base 102 side and sink in the internal space of the luminous bulb 101. An induction coil 110 including a core 106 of ferrite and a winding 105 wound around the core 106 is inserted into the cavity portion 101a. In this case, since the induction coil 110 of this embodiment includes the core 106, an induction loss occurs in the core 106 to generate heat. As a result, the temperature of the inside of the luminous bulb 101 becomes higher than that of a luminous bulb including an induction coil with no core.

The winding 105 is electrically connected to a high frequency ballast circuit 107. From the high frequency ballast circuit 107, a high frequency voltage is applied to the winding 105 to generate an alternating electromagnetic field in the luminous bulb 101. Discharge from the alternating electromagnetic field excites mercury which is a main light emitting substance in the luminous bulb 101. In other words, the high frequency ballast circuit 107 supplies electric power for generating discharge to the luminous bulb 101. The high frequency ballast circuit 107 is electrically connected to the base 102, and electric power is supplied from the commercial power line to the high frequency ballast circuit 107 via the base 102. The electrodeless fluorescent lamp of this embodiment is an electrodeless compact self-ballasted fluorescent lamp in which the luminous bulb 101, the high frequency ballast circuit 107 and a base are formed as a unit. Note that electricity consumption in the high frequency ballast circuit 107 and the luminous bulb 101 is 21 W. The cross-sections of the luminous bulb 101, the cavity portion 101a, and the case 103 are shown in FIG. 1.

On the discharge-space-side surface of the cavity portion 101a (i.e., the surface of the cavity portion 101a facing to the inner space of the luminous bulb 101), an alumina reflection film is applied as a first layer and then a luminophor is applied thereon as a second layer. In this manner, the luminophor layer 104a is formed. With this structure, ultraviolet radiation from plasma generated by the discharge makes the luminophor on the cavity portion 101a emit light, and also the emitted light can be reflected to the first reflection film and thus be prevented from being absorbed into the cavity portion 101a, and the winding 105 and the core 106 which are located therein. Thus, the amount of flux radiated to the outside of the lamp can be increased.

In this embodiment, the respective luminophors forming the luminophor layer 104a provided on part of the inner surface of the luminous bulb 101 located on the cavity portion 101a, and the luminophor layer 104 provided on the rest of the inner surface of the luminous bulb 101 have different compositions. The luminophor layer 104 provided on part of the inner surface of the luminous bulb 101 other than the cavity portion 101a includes LAP and YOX. The luminophor layer 104a provided on the cavity portion 101a includes LAP, YOX and a third luminophor. The third luminophor absorbs blue light and emits visible light with a relatively long wavelength.

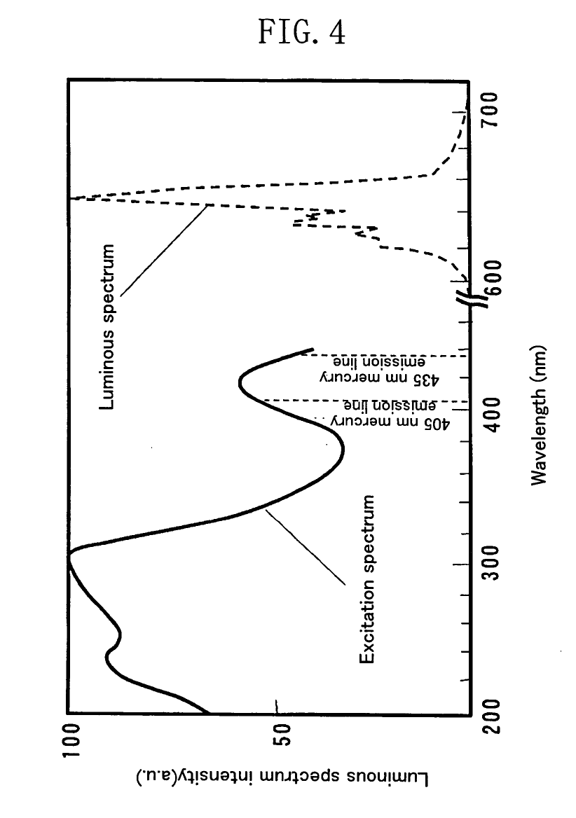

More specifically, for the luminophor layer 104a provided on the cavity portion 101a in this embodiment, a manganese-activated deep red luminescent substance MFG (3.5MgO·0.5 MgF₂.GeO: Mn4⁺) is used as the third luminophor. MFG is a luminophor which is excited by the blue 405 nm and 435 nm mercury emission lines and radiates visible light with a relatively long wavelength. FIG. 4 shows excitation spectrum and emission spectrum for MFG. In FIG. 4, the abscissa indicates wavelength (nm) and the ordinate indicates emission spectrum intensity (a.u.). Note that the emission spectrum intensities are standardized at the respective maximum values thereof.

MFG is excited by the mercury emission lines at 405 nm and 435 nm and has an emission spectrum in the deep red range from 600 nm to 700 nm. Thus, when the mercury emission lines at 405 nm and 435 nm are emitted from plasma, the electrodeless fluorescent lamp using MFG can convert the blue mercury emission lines at 405 nm and 435 nm to deep red light within a wavelength range between 600 nm and 700 nm. Thus, a color temperature close to the target color temperature of 2800 K and Duv=0 can be achieved. Note that when the color temperature is 2750 K-2850 K and Duv=−2.0-2.0, an obtained light color is almost the same as that of an incandescent lamp. Therefore, the color temperature of MFG is preferably in this range.

However, MFG has a yellowish color, and thus when it is added to the luminophor layer 104 provided on the part of inner surface of the luminous bulb 101 other than the cavity portion 101a, the color appearance of the lamp when the lamp is off becomes yellow. This will make consumers feel uneasy very much and may result in reduction in consumer interest. To avoid this, in this embodiment, MFG is contained only in the luminophor layer 104a provided on the discharge-space-side of the cavity portion 101a, as has been described. More specifically, in FIG. 1, the luminophor layer 104 provided on the inner side of an outer tube of the luminous bulb 101 having an approximately sphere shape does not contain MFG. Accordingly, the appearance thereof is white and the yellow luminophor layer 104a on the cavity portion 101a containing MFG is hidden by the luminophor layer 104 provided on the inner side of the outer tube of the luminous bulb 101 and can not be seen from the outside. Thus, the color appearance of the luminous bulb 101 is white when the lamp is off, and MFG applied onto the cavity portion 101a absorbs the mercury emission lines at 405 nm and 435 nm and emits deep red light in a wavelength range between 600 nm and 700 nm when the lamp is operated. Therefore, without Duv reduced, the color temperature of the lamp can be set closer to 2800 K.

(Other embodiments)

In the above-described embodiment, a luminophor obtained by mixing three elements, i.e., LAP, YOX, and MFG, is used as a luminophor layer 104a provided on a cavity portion 101a. However, a luminophor containing only MFG, or MFG and either one of LAP and YOX may be used. Alternatively, a luminophor other than LAP and YOX may be added.

Moreover, in the above-described embodiment, MFG is used as a luminophor which absorbs part of blue light radiated from mercury and is excited. However, the same effects as those of the present invention can be achieved when 6MgO.AsO₅: Mn⁴⁺ is used. Note that the luminophor has a yellowish color.

Furthermore, the present invention is applicable to not only an electrodeless fluorescent lamp which is a substituting lamp for an incandescent lamp but also an electrodeless fluorescent lamp in which a ballast circuit and a luminous bulb are not formed as a unit but provided separately and whose coldest point temperature is over 40 C°.

As has been described, when the coldest point temperature of a luminous bulb is over 40 C°, a luminophor which converts excessive blue radiant light having a mercury emission line to radiant light with a relatively long wavelength is mixed into a luminophor layer provided on a cavity portion. Thus, it is possible to provide, without using amalgam, an electrodeless fluorescent lamp which emits light with color temperature is 2800 K and Dvu=0, i.e., light having almost the same light color as that of an incandescent lamp.

What is claimed is:

1. An electrodeless fluorescent lamp comprising:
a luminous bulb in which mercury in a liquid state is enclosed as a light emitting substance and which includes a cavity portion;
an induction coil which is inserted into the cavity portion and generates an electromagnetic field for generating electric discharge in the luminous bulb;
a ballast circuit electrically connected to the induction coil; and
a luminophor layer which is provided on the inner surface of the luminous bulb and converts light radiated from the mercury to visible light,
wherein a manganese-activated deep red luminescent substance (3.5MgO·0.5 MgF₂.GeO₂: Mn4⁺) is contained only in part of the luminophor layer provided on a surface of the cavity portion facing the inner surface of the luminous bulb.

2. The electrodeless fluorescent lamp of claim 1, further comprising a base electrically connected to the ballast circuit,
wherein the luminous bulb, the ballast circuit and the base are formed as a unit.

3. The electrodeless fluorescent lamp of claim 1, wherein the induction coil includes a core and a winding provided around the core.
